(19) United States
(12) Patent Application Publication
(10) Pub. No.: US 2009/0193834 A1
(43) Pub. Date: Aug. 6, 2009

(54) REFRIGERATOR WITH A WATER TANK

(76) Inventors: Martin Buchstab, Bopfingen (DE); Irene Dumkow, Sontheim (DE); Adolf Feinauer, Giengen (DE); Klaus Flinner, Zöschingen (DE); Bernd Heger, Haunsheim (DE); Marek Myszko, Cambridge (GB); Peter Nalbach, Kirchheim/Nabern (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 12/310,416

(22) PCT Filed: Sep. 6, 2006
(86) PCT No.: PCT/EP2006/066068

§ 371 Date: Feb. 24, 2009

(30) Foreign Application Priority Data
Aug. 29, 2006 (DE) 10-2006-040-377.0

(51) Int. Cl. B67D 5/62; F28F 1/10

(52) U.S. Cl. 62/389; 165/181

(57) ABSTRACT

A refrigeration appliance with a water tank having an interior with an inlet connection and an outlet connection connected to a water dispenser, the water tank being divided by at least a first fin disposed in the tank interior and dividing the interior into at least two sections through which the contents of the tank flow from the inlet connection to the outlet connection, with the at least two sections merging into one another at a free edge of the fin, with the at least one fin being formed with a through-opening formed a predetermined distance from the free edge and connecting the at least two sections, the cross-sectional dimension of the through-opening being smaller than the cross-sectional dimension of the at least two sections.

The present invention relates to a refrigeration appliance with a water tank, in particular with a water tank, which is provided to be connected to the drinking water network by way of an inlet connection and supplies a drinking water dispenser or similar by way of an outlet connection.

When water is drawn from such a tank, fresh water flows in simultaneously behind it from the drinking water network, so that the tank is always completely full. When the fresh water mixes with chilled water that has already been in the tank for some time, this produces an unwanted rise in the temperature of the water drawn off, long before the quantity of water drawn off reaches the volume of the tank. To prevent this, an internal structure of the tank is expedient, whereby said tank is divided by fins arranged in its interior into sections, through which water flows in succession on the way from the inlet connection to the outlet connection. Chilled water is thus displaced by fresh water flowing in essentially without mixing, so that the temperature of the water drawn off only starts to rise when the contents of the tank are completely replaced.

With a water tank without an internal structure it is possible to remove all the air from it easily when it is first operated, if for example the inlet connection is arranged at a lowest point and the outlet connection is arranged at a highest point of the tank. Air originally contained in the tank is thus displaced completely by the water flowing in, before the water reaches the outlet connection and can be discharged. Conversely it is also possible to drain the tank completely, for example by means of suction by way of the inlet connection. With a water tank divided into sections by fins this is not possible without further ado. If a fin that separates two sections of the tank from one another is not exactly horizontal, it forms a trap either for air or for water, in other words either complete air removal or complete draining is impossible. Where there are a number of anti-parallel fins neither the one nor the other is possible. However if complete draining is not possible, there is a risk of germs developing in the tank if it is not used for some time, so that if the tank cannot be dismantled and cleaned or replaced, the water dispenser becomes unusable. Incomplete air removal causes problems in particular with a tank that is normally at atmospheric pressure. Temperature fluctuations in the tank result in major volume changes in the enclosed air, which can cause water to be displaced out of the tank; in other words the dispenser drips in an uncontrolled manner.

The object of the invention is therefore to create a refrigeration appliance with a water tank, which prevents the uncontrolled mixing of chilled water and fresh water flowing in while at the same time being such that all the air or water can still be removed easily.

The object is achieved in that with a refrigeration appliance with a water tank, which has an inlet connection and an outlet connection connected to a water dispenser and is divided by at least a first fin arranged in its interior into sections, through which the contents of the tank flow in succession on the way from the inlet connection to the outlet connection, with the sections merging into one another at a free edge of the fin, the fin is provided with a through-opening, which is arranged at a distance from the free edge and connects the sections, the free cross-section of said through-opening being smaller than the free cross-section of the respective sections. Depending on their position these through-openings allow the passage of water or air, which would otherwise be trapped in the tank.

To prevent more than a negligible quantity of water passing through the through-opening when water is drawn off, its cross-section should expediently be at most a few percent of the cross-section of the sections.

If the free edge forms a highest point of the fin, the through-opening is expediently arranged at a lowest point of the fin, or vice versa.

If the first fin abuts a wall of the water tank or a second fin in an edge opposite the free edge, the through-opening is preferably arranged adjacent to this opposite edge.

A number of first fins are preferably arranged in a straight line and parallel to one another.

If the tank is made up of a tray and cover joined together, the fins can just be formed on the tray to simplify production.

In order to stabilize the tank against any excess pressure occurring in its interior, columns are preferably distributed over the base of the tray, said columns being connected securely to the cover.

To prevent the temperature of the water drawn off rising suddenly to a significant degree, when the quantity of water drawn off in one go exceeds the volume of the tank, provision can be made for the tank to be divided into a mixing region and a laminar flow region, it being possible for the contents of the mixing region to be mixed with fresh water flowing in, while such mixing is essentially prevented in the laminar flow region. While the laminar flow region is divided into sections by the above-mentioned first fins, the mixing region is essentially free of first fins. The mixing region is preferably adjacent to the inlet connection and the laminar flow region is preferably adjacent to the outlet connection, so that during the drawing-off process water mixed in the mixing region, the temperature of which gradually rises during the course of the drawing-off process, moves up into the laminar flow region.

To allow simple air removal, the outlet connection is expediently positioned at a highest point of the water tank. In order to allow air removal from the mixing region as well, a ventilation opening expediently connects the highest point of the mixing region to the outlet connection.

A check valve upstream of the water tank makes it possible to operate the tank essentially at atmospheric pressure, so that no stringent requirements have to be specified for the strength and wall thickness of the tank.

To prevent water continuing to run at the water dispenser after the check valve has closed, the water dispenser is expediently provided with a lip valve.

Further features and advantages of the invention will emerge from the following description of exemplary embodiments with reference to the accompanying figures, in which:

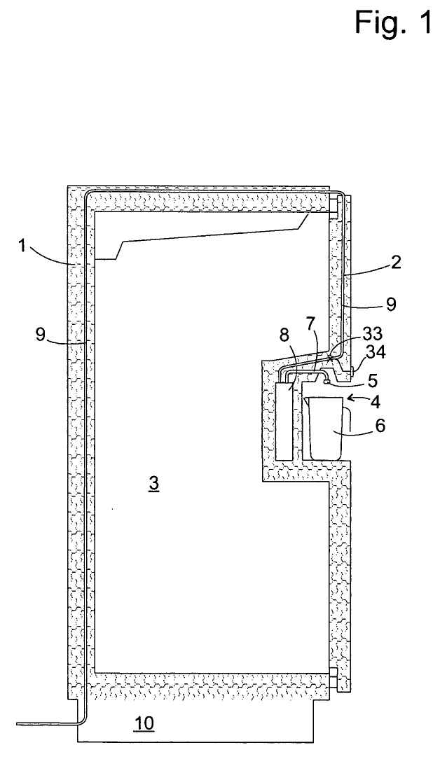

FIG. 1 shows a schematic cross-section through an inventive refrigeration appliance;

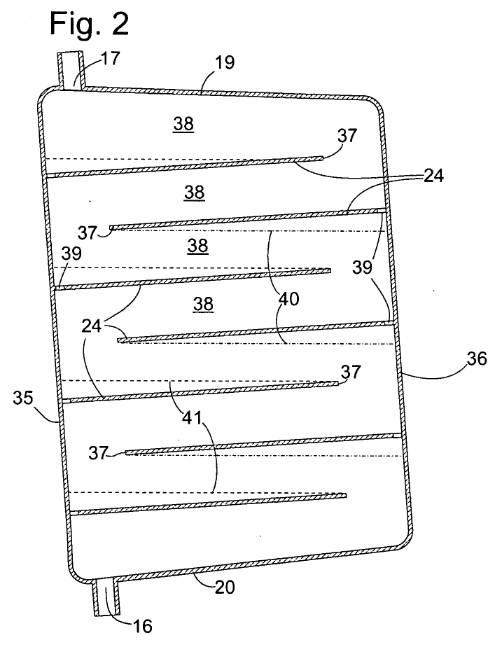

FIG. 2 shows a schematic cross-section through a water tank, showing the basic principle of the invention;

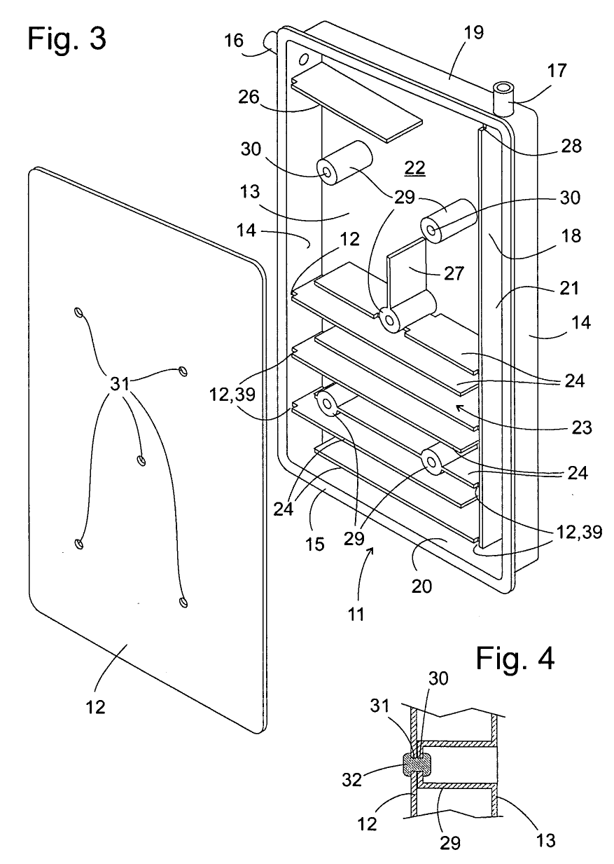

FIG. 3 shows a perspective exploded view of a water tank according to a developed embodiment;

FIG. 4 shows a cross-section of a detail of the water tank; and

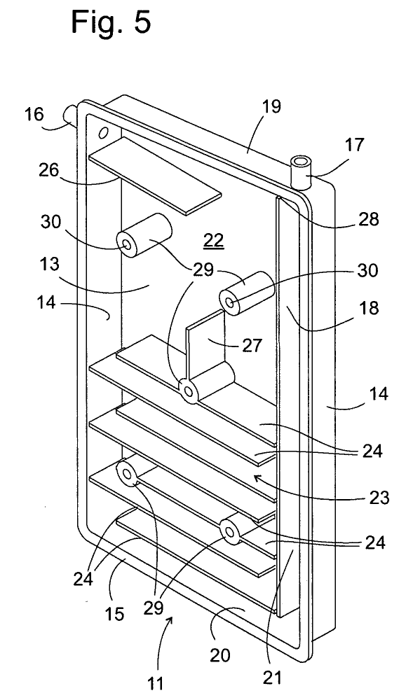

FIG. 5 shows a perspective view of the tray of a water tank according to a modified embodiment.

The refrigeration appliance shown in a schematic cross-section in FIG. 1 has a thermally insulating body 1 and a door 2, which bound a chilled interior 3. A recess 4 that opens outward is formed in a central region of the door 2, with an outlet 5 for drawing off chilled drinking water into a receptacle 6 placed in the recess 4 being arranged at the top of said recess 4. The outlet 5 is connected by way of a supply line 7 to a water tank 8 positioned in a rear wall of the recess 4. The water tank 8 is enclosed on all sides by an insulating material layer of the door 2.

The water tank 8 is connected to the drinking water network by way of a line 9, which extends out from the water tank 8 first through the door 2 by way of a hinge into the body 1 and along the latter's rear wall. The line 9 crosses a base region 10 of the body, in which a compressor (not shown) is housed. Local warming of the line 9 by waste heat from the compressor or a condenser (likewise not shown) generally mounted on the outside of the rear wall of the body 1 can therefore not be excluded.

A check valve 33 is arranged at any point in the line 9, protecting the water tank 8 from the pressure of the drinking water network when closed. The supply line 7 leading from the water tank to the outlet 5 can therefore be open in the simplest instance; however a lip valve known per se is preferably arranged at the outlet 5, to prevent the spontaneous outflow of water from the part of the supply line 7 sloping down toward the outlet 5. A button 34, which can be used to open and close the check valve 33 so that water can be drawn off, is arranged on the door adjacent to the recess 4.

FIG. 2 shows a cross-section in a plane parallel to the door 2 through the water tank 8 according to a first embodiment of the invention. The tank 8 has an essentially trapezoidal outline with an upper wall section 19, a lower wall section 20 and parallel side walls 35, 36. An inlet connection 16 and an outlet connection 17 are formed on the lower or upper wall section 20 or 19. The trapezoidal shape of the tank 8 means that the connections 16, 17 form the lowest and/or highest point of the tank 8, even if its side walls 35, 36 are not oriented exactly vertically due to tolerances in the course of its installation.

Fins 24 extend respectively out from the side walls 35, 36 at a right angle into the interior of the tank 8. The fins 24 each have a free edge 37, the distance between said free edge 37 and the respectively opposite side wall being roughly the same as the distance between the parallel fins 24. The fins 24 thus divide the interior of the tank into a plurality of longitudinally extending sections 38, which merge into one another level at a free edge 37.

Each fin 24 has a through-opening 39 at its edge connected to the side wall 35 or 36, the free cross-section of said through-opening 39 being significantly smaller than that of the sections 38. If these through-openings 39 were not present, when the tank was filled air would remain trapped below each of the fins 24 connected to the side wall 36 above a dot-dash line 40. If it expanded when the tank 8 warmed up, this would cause the outlet 5 to drip. It would also be compressed when the check valve 33 was open during a drawing-off process and the pressure in the tank was correspondingly higher than atmospheric pressure and would expand again after the check valve 33 closed, thereby causing the outlet 5 to run. The through-openings 39 however allow this air to rise in the tank and ultimately reach the outlet connection 17 along the upper wall 19. Thus in normal operating conditions the tank 8 is free of air and dripping or running is prevented.

Similarly when the tank 8 is drained, if the through-openings 39 were not present, water would remain on the fins 24 connected to the side wall 35, as shown by the broken line 41.

The through-openings 39 allow the water to collect at the inlet connection 16, so that water can be blown out or sucked away completely through the inlet connection 16.

FIG. 3 shows an exploded perspective view of the water tank 8 according to a second embodiment. The water tank 8 is made up of two parts, a tray 11 and a flat cover 12. The tray 11 has a flat base 13 parallel to the cover 12 and a narrow wall 14 running around the base 13 and supporting a flat frame 15 facing the cover 12. In the assembled state the cover 12 is secured in a leaktight manner to this frame 15 by bonding, ultrasound welding, etc. In the installed orientation of the tank 8 shown in the figure the cover 12 and base 13 are parallel to the rear wall of the recess 4.

An inlet connection 16 for connection to the line 9 and an outlet connection 17 for connection to the line 7, each in the form of a tube connection projecting as a single piece from the wall 14, are arranged respectively in an upper region of the tank 8 in the installed orientation. The interior of the water tank 8 is divided a number of times by fins projecting from the base 13 and the peripheral wall 14 of the tray 11. A first such fin 18 extends adjacent to the outlet connection 17 out from an upper section 19 of the wall 14 in a vertical direction into the vicinity of an opposite lower wall section 20, thus separating an uptake line 21 from the remainder of the interior of the tank 8.

This remainder is divided roughly in half into an upper mixing region 22 and a lower laminar flow region 23. While the mixing region 22 is largely free of fins, in the laminar flow region 23 a large number of fins 24 extend respectively in an alternating manner from the vertical fin 18 or a vertical section 25 of the wall 14 in opposing directions, thereby forcing an essentially zigzag, low-turbulence flow of water through the region 23.

A horizontal fin 26 is arranged in the mixing region 22 adjacent to the inlet connection 16, to guide inflowing water and energize it to form a rotational counter-clockwise flow in the mixing region 22. A fin 27 projecting from below into the mixing region 22 forms an obstacle to this rotational flow, at which vortices are energized in a clockwise direction, ensuring effective mixing of warm water flowing in with chilled water that has already been in the mixing region 22 for some time.

When a user draws water off from the tank, said user first receives water chilled to the stationary temperature of the water tank 8, while fresh water flowing simultaneously behind it into the mixing region 22 warms it gradually. This water, which gradually becomes warmer over time, moves up into the laminar flow region 23. When the quantity of water drawn off reaches the volume of the laminar flow region 23, the water mixed with fresh water reaches the outlet 17 and the temperature of the water drawn off gradually rises. A user can tell from the gradual rise in the temperature of the water drawn off that the tank 8 requires a rest period before it can supply properly chilled water once again.

The base 13 of the tank is not exactly rectangular but trapezoidal, so that when installed the lower wall section 20 is horizontal, while the upper wall section 19 in contrast rises slightly toward the outlet connection 17. A through-opening 28 is formed in the fin 18 immediately adjacent to the wall section 19, the free cross-section of said through-opening 28 being significantly smaller than that of the uptake line 21 or the line sections bounded by the fins 24 of the laminar flow region 23, so that when water is drawn off, the water throughput through the through-opening 28 is small compared with the quantity of water flowing through the laminar flow region 23 and has no significant influence on the temperature of the water drawn off. However when the tank 8 is first operated, the through-opening 28 allows the air initially contained in the mixing region 22 to reach the outlet connection 17 and escape from the tank.

A notch opening toward the cover 12 is formed on the edge of each fin 24 connected to the outer wall 14 or the vertical fin 18, bounding a through-opening 39 together with the cover 12 when said cover 12 is mounted on the tray 11. As in the embodiment in FIG. 2 these through-openings 39 allow air trapped in the tank during the filling process to rise up in the tank 8 or water trapped during the draining process to flow down. Applying compressed air to the inlet connection 16 allows this water to be driven out by way of the uptake line 21 and the outlet connection 17.

A number of columns 29 are distributed over the base 13 of the tray 11 with a height corresponding respectively to the width of the wall 14 or the fins 18, 24, 26, 27. An arrangement of five columns 29, distributed in the manner of spots on a die, as shown in FIG. 3, is preferred but other numbers of columns 29 can be provided, depending on the size of the base 13. The columns 29 can each have a closed end face, which like the frame 15 is secured to the cover 12, to prevent or at least limit deformation of the tank 8 when subject to the pressure of the water contained therein. However the columns 29 are preferably hollow, as shown in the cross-section in FIG. 4, and have an opening 30 on their end faces, aligned with a respectively corresponding opening 31 on the cover 12, to accommodate a rivet 32.

The modified embodiment of the tray 11 shown in FIG. 5 differs from the one in FIG. 3 in that the through-openings 39 respectively have the form of narrow slots, which extend over the entire width of the fins 24. In other words in this variant the fins 24 are connected neither to the vertical fin 18 nor to the side wall 35 of the tray 11 but only to its base 13. The gaps 39 are so narrow however that during the drawing-off process the water is forced to flow on a zigzag path around the fins 24, as in the embodiment in FIG. 3.

1-14. (canceled)

15. A refrigeration appliance with a water tank having an interior with an inlet connection and an outlet connection connected to a water dispenser, the water tank being divided by at least a first fin disposed in the tank interior and dividing the interior into at least two sections through which the contents of the tank flow from the inlet connection to the outlet connection, with the at least two sections merging into one another at a free edge of the fin, the refrigeration appliance comprising the at least one fin being formed with a through-opening formed a predetermined distance from the free edge and connecting the at least two sections, the cross-sectional dimension of said through-opening being smaller than the cross-sectional dimension of the at least two sections.

16. The refrigeration appliance according to claim 15 wherein the free edge forms a highest point of the first fin and the through-opening is formed at a lowest point of the first fin.

17. The refrigeration appliance according to claim 15 wherein the free edge forms a lowest point of the first fin and the through-opening is formed at a highest point of the first fin.

18. The refrigeration appliance according to claim 15 wherein the first fin abuts at least one of a wall of the water tank or a second fin at an edge opposite the free edge and the through-opening is arranged adjacent the opposite edge.

19. The refrigeration appliance according to claim 15 wherein a plurality of first fins linearly extends in an arrangement wherein the fins are arranged disposed generally parallel to one another.

20. The refrigeration appliance according to claim 15 wherein the tank is formed from a tray and a cover joined together and the first fin is formed on the tray.

21. The refrigeration appliance according to claim 20 wherein the tank includes columns connected to the cover and distributed over the base of the tray.

22. The refrigeration appliance according to claim 15 wherein the tank is divided into a mixing region that is essentially free of first fins and a laminar flow region which is connected in series to the mixing region and is divided into sections by the first fins.

23. The refrigeration appliance according to claim 22 wherein the mixing region is adjacent the inlet connection and the laminar flow region is adjacent the outlet connection.

24. The refrigeration appliance according to claim 15 wherein the outlet connection is positioned at a highest point of the water tank.

25. The refrigeration appliance according to claim 24 wherein the highest point of the mixing region is connected to the outlet connection by a vent opening.

26. The refrigeration appliance according to claim 15 and further comprising a check valve disposed upstream of the water tank.

27. The refrigeration appliance according to claim 26 wherein the water dispenser includes a lip valve.

28. The refrigeration appliance according to claim 15 wherein the water tank is mounted flush with a housing wall of the refrigeration appliance.
